(19) United States
(12) Patent Application Publication
(10) Pub. No.: US 2010/0250052 A1
(43) Pub. Date: Sep. 30, 2010

(54) In-vehicle monitor for monitoring vehicle status

(75) Inventor: Kenichi Ogino, Toyota-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/661,841

(22) Filed: Mar. 25, 2010

(30) Foreign Application Priority Data
Mar. 26, 2009 (JP) 2009-77132

(51) Int. Cl. G06F 7/00; H04N 7/18

(52) U.S. Cl. 701/33; 701/29; 348/148; 348/E07.085

(57) ABSTRACT

An in-vehicle monitor for monitoring a status of a vehicle includes: a monitoring means for monitoring the status of the vehicle; a determination means for determining based on the status of the vehicle whether an obstacle interrupts an operation of an operation object when a user inputs an operation instruction for operating the operation object; and a controller for controlling the operation object to execute the operation corresponding to the operation instruction when the determination means determines that the obstacle does not interrupts the operation, and for controlling the operation object to execute another operation different from the operation corresponding to the operation instruction when the determination means determines that the obstacle interrupts the operation.

### CROSS REFERENCE TO RELATED APPLICATION

This application is based on Japanese Patent Application No. 2009-77132 filed on Mar. 26, 2009, the disclosure of which is incorporated herein by reference.

### FIELD OF THE INVENTION

The present invention relates to an in-vehicle monitor for monitoring status information of a vehicle.

### BACKGROUND OF THE INVENTION

Conventionally, to monitor status information of a compartment of a vehicle, a detection means such as a camera is used for. The monitor functions as a device for noticing things left in the compartment when a passenger of the vehicle gets out of the vehicle. The monitor is disclosed in, for example, JP-A-2005-115911.

JP-A-2005-115911 teaches a lost item warning, device, which shoots an image of a compartment in the vehicle with using a camera when the passenger gets in the vehicle, and stores the image in a memory of an image processing circuit. Further, the device shoots an image of the compartment in the vehicle with using the camera when the passenger gets out of the vehicle, and stores the image in the memory of the image processing circuit. The device compares the image of the compartment in case of getting in the vehicle with the image in case of getting out of the vehicle, so that the device determines whether a lost item exists in the compartment. When the device determines that the lost item exists in the compartment, the device notifies existence of the lost item in the compartment with using a notification means.

In a conventional art, a user directly operates an operation means such as a switch and a lever in the compartment when the user controls a part of the vehicle such as a sliding door, a rear seat door, a trunk lid, a power window and a seat. Alternatively, when the user controls the part of the vehicle, the user may remotely operate the operation means with a remote keyless entry (RKE) device even when the user is disposed outside of the vehicle.

Thus, when the user remotely operate or directly operate the operation means to function the part of the vehicle, for example, a child may be stuck in a power window in a case where the child is in the compartment, and the user operates the power window. Further, when an expensive item is disposed in the compartment, and the user operates the seat remotely or directly, the extensive item may be broken. Furthermore, when a child is near the vehicle, and the user operates to open the trunk lid, the trunk lid may hit on the child.

Although the above lost item warning device monitors the status information of the compartment, the device merely determines whether the lost item exists in the compartment so that the device prevents the user from forgetting the item in the compartment. However, the lost item warning device cannot prevent the above difficulties.

### SUMMARY OF THE INVENTION

In view of the above-described problem, it is an object of the present disclosure to provide an in-vehicle monitor for monitoring a vehicle and for securing safety of operation of a part of the vehicle.

According to a first aspect of the present disclosure, an in-vehicle monitor for monitoring a status of a vehicle including a status of an operation object, which is operated by a user, the monitor includes: a monitoring means for monitoring the status of the vehicle; a determination means for determining based on the status of the vehicle whether an obstacle interrupts an operation of the operation object when the user inputs an operation instruction for operating the operation object; and a controller for controlling the operation object to execute the operation corresponding to the operation instruction when the determination means determines that the obstacle does not interrupts the operation, and for controlling the operation object to execute another operation different from the operation corresponding to the operation instruction when the determination means determines that the obstacle interrupts the operation.

When the user inputs the operation instruction, the determination means determines whether the obstacle interrupts the operation of the operation object before the operation of the operation object is executed. Thus, when the obstacle interrupts the operation of the operation object, the monitor restricts the obstacle from being damaged by the operation of the operation object. Thus, the safety of the operation of the operation object is improved. Further, since the operation object executes the operation different from the operation corresponding to the operation instruction, the user understands the different operation of the operation object so that the user recognizes existence of the obstacle.

According to a second aspect of the present disclosure, an in-vehicle monitor for monitoring a status of a vehicle includes: a camera for shooting an image of the vehicle; a memory for storing a reference image, which is preliminary shot by the camera; an image processor for comparing the image of the vehicle with the reference image so that the image processor determines whether an obstacle interrupts an operation of an operation object, which is operated by a user; and a controller for controlling the operation object to execute the operation corresponding to an operation instruction of the user when the image processor determines that the obstacle does not interrupt the operation, and for controlling the operation object not to execute the operation corresponding to the operation instruction when the image processor determines that the obstacle interrupts the operation.

When the user inputs the operation instruction, the image processor determines whether the obstacle interrupts the operation of the operation object before the operation of the operation object is executed. Thus, when the obstacle interrupts the operation of the operation object, the monitor restricts the obstacle from being damaged by the operation of the operation object. Thus, the safety of the operation of the operation object is improved. Further, since the operation object does not execute the operation, the user recognizes existence of the obstacle.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an electric construction of a vehicle, on which an in-vehicle monitor is mounted;

FIG. 2 is a block diagram showing an electric construction of a controller in the monitor;

FIG. 3 is a diagram showing a detection area of the monitor; and

FIG. 4 is a flowchart showing a monitoring process in the controller.

### DETAILED DESCRIPTION OF THE PREFERRED EMBODIMENTS

### First Embodiment

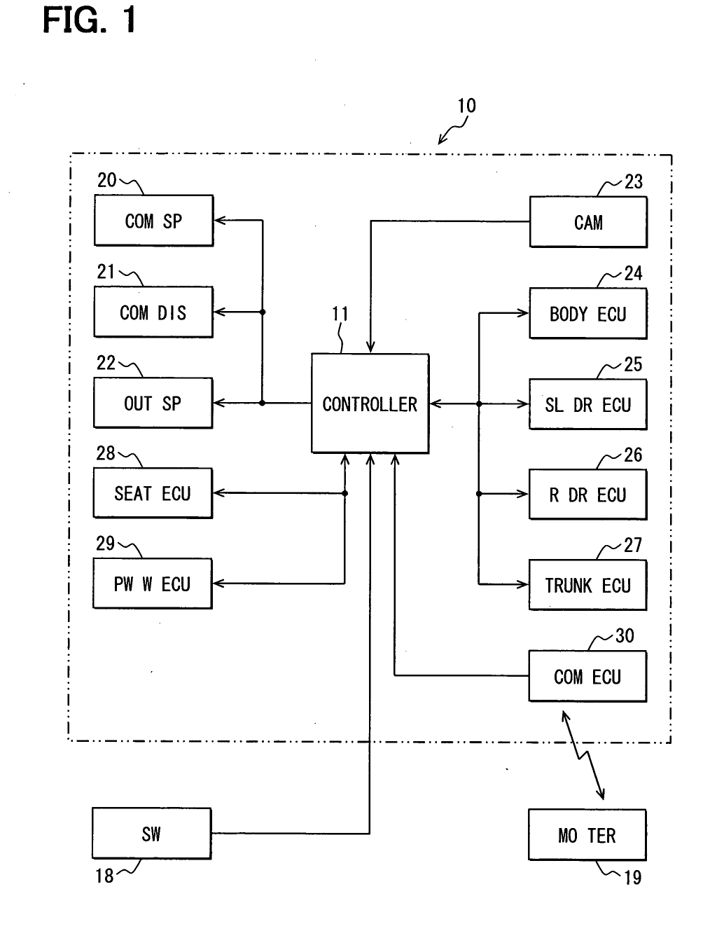

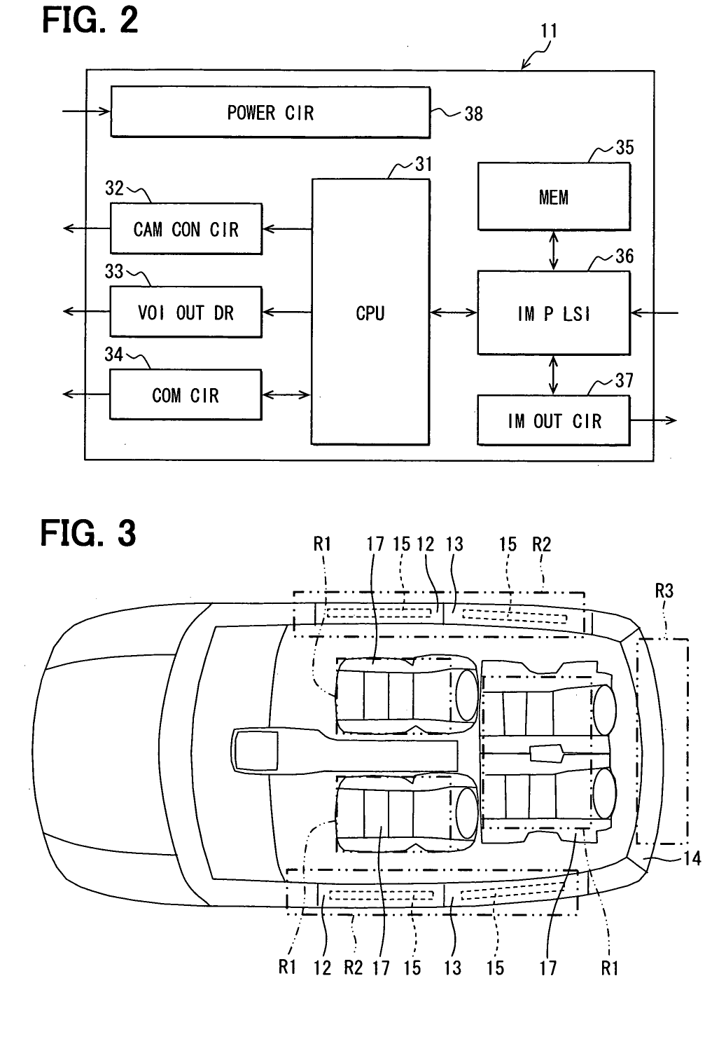

FIG. 1 shows an electric construction of a vehicle, on which an in-vehicle monitor 10 is mounted. FIG. 2 shows an electric construction of a controller 11 in the monitor 10. FIG. 3 shows a detection area of the monitor. The monitor 10 monitors status information of the vehicle including status of a part of the vehicle as an operation object, which is operated by a user operation. Based on a monitoring result, the monitor 10 determines availability of operation of the object. The operation object is, for example, a sliding door 12, a rear seat door 13, a trunk lid 14, a power window 15 and a seat 17. When the user operates an operation switch 18 disposed in a compartment of the vehicle and a mobile terminal as a remote controller 19 carried by the user, the operation object is operated. The monitor 10 includes a controller 11, a compartment speaker 20, a compartment display 21, an outside speaker 22, a camera 23, a body electronic control unit (ECU) 24, a sliding door ECU 25, a rear seat door ECU 26, a trunk ECU 27 a seat ECU 28, a power window ECU 29 and a communication ECU 30, as shown in FIG. 1. The compartment speaker 20 and the compartment display 21 are disposed in the compartment.

The camera 23 functions as a monitoring means for monitoring the status information of the vehicle. The camera 23 shoots an image of the compartment. Based on information from the controller 11, the camera shoots the compartment, and then, the camera 23 outputs the image of the compartment to the controller 11. The camera 23 is energized from an in-vehicle battery at least when the user gets in the vehicle. The camera 23 may include a light for shooting an image of the compartment at night and a night vision function. Further, the camera 23 may be provided by a camera for a vehicle antitheft system. The camera 23 may be arranged near a rear view mirror. Further, the camera 23 may be provided by a camera for rear view monitor.

Each of the body ECU 24, the sliding door ECU 25, the rear seat door ECU 26, the trunk lid ECU 27, the seat ECU 28, the power window ECU 29 and the communication ECU 30 includes a conventional computer. Accordingly, an internal construction of the body ECU 24, the sliding door ECU 25, the rear seat door ECU 26, the trunk lid ECU 27, the seat ECU 28, the power window ECU 29 and the communication ECU 30 are substantially the same. For example, the internal construction includes a central processing unit (CPU), a read only memory (ROM), a random access memory (RAM), an input and output device (I/O) and a bus line, which connects the CPU, the ROM, the RAM and the I/O.

The body ECU 24 is connected to a shift position sensor, an accessory switch, an ignition switch and the like so that the body ECU 24 receives information from the shift position sensor, the accessory switch, the ignition switch and the like, and outputs the information to the controller 11 by a CAN (controller area network) communication method.

The sliding door ECU 25 controls to lock and unlock the sliding door 12. The sliding door ECU 25 further controls to open and close the sliding door 12 based on an operation instruction from the controller 11. The sliding door ECU 25 is connected to a courtesy switch so that the ECU 25 detects information about open and close of the sliding door 12 based on information from the courtesy switch. The detection result is output to the controller 11 by the CAN communication method.

The rear seat door ECU 26 has substantially the same construction as the sliding door ECU 25. The control object of the sliding door ECU 25 is the sliding door 12, and the control object of the rear seat door ECU 26 is the rear seat door 13. Accordingly, the rear seat door ECU 26 controls to lock and unlock the rear seat door 13. The rear seat door ECU 26 further controls to open and close the rear seat door 13 based on an operation instruction from the controller 11. The rear seat door ECU 26 is connected to a courtesy switch so that the ECU 26 detects information about open and close of the rear seat door 13 based on information from the courtesy switch. The detection result is output to the controller 11 by the CAN communication method.

The trunk lid ECU 27 has substantially the same construction as the sliding door ECU 25. The control object of the sliding door ECU 25 is the sliding door 12, and the control object of the trunk lid ECU 27 is the trunk lid 14.

Accordingly, the trunk lid ECU 27 controls to lock and unlock the trunk lid 14. The trunk lid ECU 27 further controls to open and close the trunk lid 14 based on an operation instruction from the controller 11. The trunk lid ECU 27 is connected to a courtesy switch so that the ECU 27 detects information about open and close of the trunk lid 14 based on information from the courtesy switch. The detection result is output to the controller 11 by the CAN communication method.

The power window ECU 29 controls to open and close the power window 15 of each door of the vehicle based on an operation instruction from the controller 11. The power window ECU 29 detects information about open and close of the power window 15, and then, the ECU 29 outputs the detection result to the controller 11 by the CAN communication method.

The seat ECU 28 controls a position of each seat 17 based on an operation instruction from the controller 11. The seat ECU 28 detects the position of the seat 17, and outputs the detection result to the controller 11 by the CAN communication method.

The communication ECU 30 functions as a first communication means for executing data communication between the ECU 30 and the mobile terminal 19 of the user. When the ECU 30 receives data from the terminal 19, the ECU 30 functions as an in-vehicle small wireless receiver. The ECU 30 receives information from the mobile terminal 19 such as a remote controller carried by the user without wires. The information received by the ECU 30 relates to, for example, an operation instruction for functioning an operation object. Specifically, the information relates to an operation instruction of locking and unlocking each door, an operation instruction of opening and closing the trunk lid, and an operation instruction of opening and closing the power window. The communication ECU 30 inputs the information into the controller 11.

When the communication ECU 30 transmits data, the ECU 30 transmits information to the mobile terminal 19. The communication ECU 30 functions as a second communication means for communicating with an external device, which is not mounted on the vehicle. The ECU 30 communicates with an information center as the external device via a public line. The communication ECU 30 transmits the information from the controller 11 to the information center. Thus, the information is transmitted to the mobile terminal carried by the user via the information center. The mobile terminal is, for example, a cell phone as a communication device. The information transmitted by the communication ECU 30 is, for example, status information about the vehicle such as an image shot by the camera 23.

The compartment speaker 20 functions as a notification means for outputting sound information into the compartment. The compartment speaker 20 is arranged in the compartment. The speaker 20 outputs voice or sound based on the information from the controller 11. For example, the speaker 20 is provided by a sound output means in a navigation device or an audio device.

The compartment display 21 functions as a notification means for outputting the image information. The display 21 is arranged in the compartment. The display 21 outputs the image based on the information from the controller 11. The display 21 is provided by, for example, an image display means in the navigation device or the audio device.

The speaker 22 functions as a notification means for outputting sound information to the outside of the vehicle. The speaker 22 is arranged on the outside of the compartment. The speaker 22 outputs sound based on the information from the controller 11. The speaker 22 is provided by a sound output means for notifying a status of a door such as a locking state so that the speaker 22 functions as an answer back system.

Next, the controller will be explained with reference to FIG. 2. The controller 11 is electrically coupled with the compartment speaker 20, the compartment display 21, the outside speaker 22, the camera 23, the body ECU 24, the sliding door ECU 25, the rear seat door ECU 26, the trunk ECU 27, the seat ECU 28, the power window ECU 29, the communication ECU 30 and the operation switch 18. The controller 11 controls each part of the vehicle based on the operation instruction obtained from the operation switch 18 and the communication ECU 30.

The controller 11 is provided by a conventional computer, as shown in FIG. 2. The controller 11 includes a CPU 31, a camera control circuit 32, a sound output driver 33, a communication circuit 34, a memory 35, an image processing large scale integration (LSI) 36, an image output circuit 37, a power source circuit 38, and a bus line (not shown), which connects the CPU 31, the camera control circuit 32, the sound output driver 33, the communication circuit 34, the memory 35, the image processing LSI 36, the image output circuit 37 and the power source circuit 38.

The camera control circuit 32 outputs camera control information to the camera 23 based on instruction information of the CPU 31. The sound output driver 33 outputs sound output information to the speaker 20 and the outside speaker 22 based on instruction information from the CPU 31. The communication circuit 34 communicates with each ECU 24-30 by the CAN communication method. The CPU 31 executes a calculation process according to the input information and a predetermined program so that the CPU 31 so that the CPU 31 outputs the instruction information to an electric device, which is connected to the CPU 31.

The memory 35 is a memory means for storing information. For example, the memory 35 stores an image of the compartment shot by the camera 23 and a reference image as a default image of the compartment. The default image is an initial image in a default state of the compartment. The default state is a reference state for comparing the image with the reference image. For example, the default image corresponds to a state of the compartment when the vehicle is delivered for the first time. Alternatively, the default image corresponds to a state of the compartment when the user uses the vehicle normally without forgetting something in the compartment.

The image processing LSI 36 executes an image process. The LSI 36 specifies predetermined detection areas R1-R3 based on the image of the compartment shot by the camera 23. The LSI 36 executes a comparison process of the images. Specifically, the LSI 36 compares the image of the compartment shot by the camera 23 with the default image stored in the memory 35 with respect to the detection areas R1-R3. The image output circuit 37 outputs image output information to the display 21. The power source circuit 38 controls to energize the camera 23 with using a battery (not shown).

The detection areas R1-R3 will be explained with respect to FIG. 3. The detection areas R1-R3 corresponds to space in the compartment in an operation range of the sliding door 12, the rear seat door 13, the trunk lid 14, the power window 15 and the seat 17. Accordingly, the detection areas R1-R3 is preliminary set to a first detection area R1 around the seat 17, the second detection area R2 around each door and the third detection area R3 around the trunk lid 14. Thus, by specifying the detection areas R1-R3, data used in the image processing of the LSI 36 is reduced. Accordingly, the process time of the image processing of the LSI 36 is reduced.

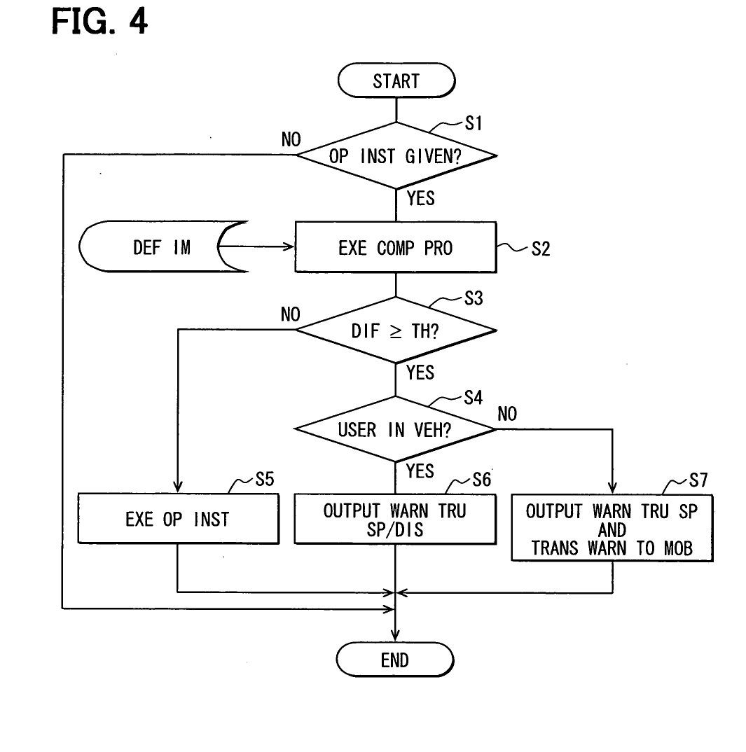

Next, the monitoring process executed by the controller 11 will be explained. FIG. 4 shows a flowchart of the monitoring process in the controller 11. The monitoring process is repeated in a short time when the controller 11 is energized. Further, when the controller 11 is energized, the camera 23 shoots an image of the situation in the compartment, and then, the image information is input into the controller 11.

In step S1, the controller 11 determines whether an operation instruction is given. When the operation instruction is given, it goes to step S2. When the operation instruction is not given, the process ends. The operation instruction is information input by the user when the user operates the operation switch 18 and the mobile terminal 19.

In step S2, since the operation instruction is given, the LSI 36 executes the image comparison process so that the LSI 36 determines whether an obstacle prevents the operation when the operation object is operated according to the operation instruction. Then, it goes to step S3. In step S2, the LSI 36 functions as a determination means for determining existence of the obstacle. The LSI 36 specifies one of the detection areas R1-R3 corresponding to the operation object. The LSI 36 compares the image of the one of the detection areas R1-R3 in the compartment shot' by the camera 23 at a time when the operation instruction is given with the default image stored in the memory 35. The one of the detection areas R1-R3 corresponding to the operation object is, for example, the first detection area R1 around the seta 17 when the operation instruction is to displace the seta 17. Further, when the operation instruction is to open and close the sliding door 12 and the power window 15, the one of the detection areas R1-R3 is the second detection area R2 around each door. When the operation instruction is to open and close the trunk lid 14, the one of the detection areas R1-R3 is the third area R3 around the trunk lid 14.

In step S3, the LSI 36 compares the image in the compartment at the present time with the default image so that the controller 11 determines whether the obstacle exists. When a difference value between the current image and the default image is equal to or larger than a predetermined value, the controller 11 determines that the obstacle exists. Then, it goes to step S4. When the difference value between the current image and the default image is smaller than the predetermined value, the controller 11 determines that the obstacle does not exist. Then, it goes to step S5.

In step S5, since the controller 11 determines that the obstacle does not exist, the controller 11 controls the operation object to execute operation according to the operation instruction. Then, the process ends.

In step S4, since the controller 11 determines that the obstacle exists in the one of the detection areas R1-R3 corresponding to the operation object, the controller 11 determines whether the operation instruction is input from the operation switch 18 or the mobile terminal 19. When the controller 11 determines that the operation instruction is input from the operation switch 18, it goes to step S6. When the controller 11 determines that the operation instruction is input from the mobile terminal 19, it goes to step S7.

In step S6, since the obstacle exists in the one of the detection areas R1-R3, and the operation instruction is input by the operation switch 18, the user is disposed in the vehicle. Thus, in this case, the controller 11 controls the compartment speaker 20 to output sound output information, which shows the existence of the obstacle. Further, the controller 11 controls the display 21 to output image output information, which shows the existence of the obstacle. Then, the process ends. Thus, the monitor 10 notifies the user of existence of the obstacle.

In step S7, since the obstacle exists in the one of the detection areas R1-R3, and the operation instruction is input by the mobile terminal 19, the user is disposed outside of the vehicle. Thus, in this case, the controller 11 controls the outside speaker 22 to output sound output information, which shows the existence of the obstacle. Further, the controller 11 controls the communication ECU 30 to transmit the information of existence of the obstacle to the mobile terminal 19 or another cell phone carried by the user. Then, the process ends.

The information to be transmitted to the mobile terminal 19 or another cell phone is, for example, sound information, word information and image information. When the process ends through step s4, the operation instruction is cancelled, so that the operation instruction is not executed. Thus, the controller 11 is a controlling means. When the operation instruction is input into the controller 11, and the controller 11 controls the operation object to function according to the operation instruction, the controller 11 determines based on the image information obtained from the camera 23 whether the obstacle that interrupts the operation of the operation object exists around the operation object. When the controller 11 determines with using the LSI 36 that the obstacle does not exist, the controller 11 controls the operation object to function according to the operation instruction. When the controller 11 determines that the obstacle exists, the controller 11 does not execute the operation according to the operation instruction, and the controller 11 controls several parts of the vehicle to notify the information about the obstacle.

Accordingly, for example, when the operation instruction is to open and close the sliding door 12, the controller 11 determines whether the obstacle is stuck in the sliding door 12, i.e., the controller 11 determines whether the obstacle exists near the sliding door 12 so that the obstacle is stuck when the sliding door 12 is operated. Based on the determination of possibility of sticking the obstacle with the sliding door 12, the controller 11 determines allowance of the opening and closing operation of the sliding door 12. When the operation instruction is to open and close the power window 15, the controller 11 determines whether the obstacle such as a hand of a child is stuck in the power window 15, i.e., the controller 11 determines whether the obstacle exists near the power window 15 so that the obstacle is stuck when the power window 15 is operated. Based on the determination of possibility of sticking the obstacle with the power window 15, the controller 11 determines allowance of the opening and closing operation of the power window 15. When the operation instruction is to displace the seat 17, the controller 11 determines whether the obstacle such as a child and a baggage is stuck in the seat 17, i.e., the controller 11 determines whether the obstacle exists near the seat 17 so that the obstacle is stuck when the seat 17 is operated. Based on the determination of possibility of sticking the obstacle with the seat 17, the controller 11 determines allowance of the displacing the seat 17. When the operation instruction is to open and close the trunk lid 14, the controller 11 determines whether the obstacle such as a child and a baggage contacts the trunk lid 14, i.e., the controller 11 determines whether the obstacle exists near the trunk lid 14 so that the trunk lid 14 contacts the obstacle when the trunk lid 14 is opened and closed. Based on the determination of possibility of contacting the obstacle with the trunk lid 14, the controller 11 determines allowance of the opening and closing the trunk lid 14.

When the user disposed outside of the vehicle approaches the vehicle, and the operation instruction for opening the sliding door 12 is automatically transmitted from the mobile terminal 19 carried by the user to the vehicle within a predetermined range between the mobile terminal 19 and the vehicle, the controller 11 determines the possibility of sticking the obstacle in the sliding door 12 when the sliding door 12 automatically opens. Specifically, when the mobile terminal 19 is set to an automatic opening mode, the controller 11 determines whether the obstacle exists near the sliding door 12 so that the obstacle is stuck in the sliding door 12 when the sliding door 12 is automatically opened. Thus, based on the determination of existence of the obstacle, the controller 11 determines allowance of the opening the sliding door 12. Thus, when the user approaches the vehicle, the sliding door 12, the rear seat door 13, the trunk lid 14, the power window 15 and the seat 17 are safely operated. Specifically, in a case where the user set such that the seat 17 is automatically reclined, and the rear seat door 13 is automatically opened when the user approaches the vehicle after the user buys something at a shopping mall, the controller 11 determines existence of the obstacle so that the seat 17 and the rear seat door 13 are safely reclined and opened automatically.

When the user is disposed at a position, at which the user cannot view the vehicle, and the user transmits the operation instruction for opening the power window 15 from the mobile terminal 19 in order to ventilate air in the compartment, the controller 11 determines allowance of opening and closing the power window 15 based on the possibility of theft of items in the compartment when the power window 15 is opened. Specifically, based on existence of a person around the vehicle, the controller 11 determines whether the operation of the power window 15 is executed. Specifically, when there is a person near the vehicle, the controller 11 determines existence of the obstacle, and the controller 11 does not execute to open the power window 15.

Thus, in the monitor 10, when the user as an operator of the monitor 10 operates the switch 18 and/or the mobile terminal 19, the controller 11 determines whether the obstacle such as a child, an animal and a baggage exists so that the obstacle interrupts operation of the operation object before the operation of the operation object is executed. When there is no obstacle, the controller 11 controls the operation object to execute a normal operation according to the operation instruction. When there is the obstacle, the controller 11 controls the operation object not to execute the operation according to the instruction. In this case, the controller 11 controls the operation object to perform cancellation of the operation, which is different from the operation corresponding to the operation instruction. Thus, when there is the obstacle, the monitor 10 protects the obstacle from being damaged when the operation object is operated normally. Thus, the monitor 10 provides to improve safety of the operation of the operation object. Further, since the operation of the operation object in a case where the obstacle exists is different from the normal operation, the user recognizes existence of the obstacle based on the different operation of the object. Thus, when the user moves the obstacle or the user removes the interruption of the obstacle, the controller 11 controls the operation object to execute the operation. Thus, for example, even when the user operates remotely the operation object, the operation object such as the sliding door 12, the rear seat door 13, the trunk lid 14, the power window 15 and the seat 17 is safely operated. Further, even when the monitor 11 works with an automatic opening system, the monitor 10 provides safety of automatic control.

In the present embodiment, the user easily recognizes the obstacle based on the output from the speakers 20, 22 and the display 21. Thus, convenience of the operation is improved.

The LSI 36 compares the image at a time when the user operates the switch 18 or the mobile terminal 19 with the default image, so that the controller 11 surely detects the obstacle, which provides the possibility of interruption with respect to the operation object. Thus, the reliability of determination of existence of the obstacle is improved.

In the present embodiment, the mobile terminal 19 transmits the operation instruction by air. Thus, the mobile terminal 19 is an operation means capable of operating the object remotely. When the user is disposed at a place far from the vehicle, and the user operates the operation object with using the mobile terminal 19, the user cannot view the vehicle, and cannot confirm existence of the obstacle directly, compared with a case where the user is gets in the vehicle, and the user operates the operation object. In such a case where the user cannot directly watch the vehicle and the obstacle, conventionally, the obstacle may be damaged by the operation of the object. However, in the present embodiment, since the controller 11 determines existence of the obstacle, and the controller 11 determines allowance of operation of the object, even when the user remotely operates the object with using the mobile terminal 19, the safety operation is secured.

In the present embodiment, the information showing existence of the obstacle is transmitted from the communication ECU 30 to a communication device such as a cell phone. The user can recognize existence of the obstacle easily with using the cell phone or the like even when the user is disposed far from the vehicle. Thus, convenience is improved.

### Other Embodiments

The monitoring means for monitoring the vehicle is the camera 23 having a shooting function. Alternatively, the monitoring means may be other devices. For example, the monitoring means may be an intrusion detection sensor, a seating sensor and a temperature sensor. The intrusion detection sensor detects intrusion of an intruder into the compartment. Further, the intrusion detection sensor detects approach of the intruder, who tries to intrude into the compartment. The intrusion detection sensor emits a transmission' wave into the compartment and/or toward the outside of the vehicle. The intrusion detection sensor receives a reflection wave so that the intrusion detection sensor detects the intrusion into the compartment and approach to the vehicle. Although the camera 23 shoots the compartment, the camera 23 may shoot both of the compartment and the outside of the vehicle.

In the above embodiment, when the controller 11 determines that there is the obstacle, the controller 11 controls the object not to execute the operation. Alternatively, the controller 11 may control to operate the object with a slow operation speed even when the controller 11 determines that there is the obstacle. In this case, the operation speed of the object is slower than that of the normal operation. Thus, the object is controlled to execute slowly.

In the first embodiment, after the operation instruction is given, the LSI 36 executes the image comparison process. Alternatively, the LSI 36 may execute the image comparison process periodically, and store the execution result in the memory 35. Thus, since the controller controls based on the comparison result preliminary executed without waiting for the image processing result of the LSI 36, a process time of the monitoring process is shortened.

In the above embodiment, the monitor 10 for a vehicle functions as an independent monitor 10. Alternatively, the monitor 10 may function together with other devices and may be provided by a part of other devices, so that the monitor 10 is prepared. The monitor 10 may be a part of a device for detecting and noticing things left in the compartment. Alternatively, the monitor 10 may be a part of a vehicle antitheft system for monitoring and notifying intrusion of a stranger into the compartment. Alternatively, the monitor 10 may be a part of a drive recorder for recording a driving condition.

In the above embodiment, the monitoring process is executed without depending on a situation whether the operation instruction is input from the operation switch 18 in the compartment or the operation instruction is transmitted from the mobile terminal 19. Alternatively, the monitoring process may be executed only in one of cases. Accordingly, for example, when the monitoring process is executed only by the operation instruction transmitted from the mobile terminal 19, the safety in case of remote control is improved. When the user in the compartment directly operates the operation switch 18, it is possible for the user to see directly and confirm safety. In this case, the monitoring process is not executed, so that the process load of the controller 11 is reduced.

In the above embodiment, the user inputs the operation instruction with the mobile terminal 19. The monitor 10 transmits the information to the mobile terminal 19 and the cell phone. Alternatively, the monitor 10 may further transmit the information to other information terminals such as a computer arranged in a house. Alternatively, the monitor 10 may further transmit the information to an information terminal via a wireless LAN. Alternatively, the monitor 10 may not transmit the information to the cell phone, and transmit only to the mobile terminal 19. Alternatively, the cell phone may include a function of the mobile terminal 19 so that the cell phone provides the mobile terminal 19. In this case, the user merely carries one external device such as the cell phone. Then, the user inputs the operation instruction with using the cell phone so that the cell phone transmits the operation instruction to the monitor 10. Further, the user receives the information from the monitor 10 with using the cell phone. In this case, convenience of the monitor 10 is much improved.

The above disclosure has the following aspects.

According to a first aspect of the present disclosure, an in-vehicle monitor for monitoring a status of a vehicle including a status of an operation object, which is operated by a user, the monitor includes: a monitoring means for monitoring the status of the vehicle; a determination means for determining based on the status of the vehicle whether an obstacle interrupts an operation of the operation object when the user inputs an operation instruction for operating the operation object; and a controller for controlling the operation object to execute the operation corresponding to the operation instruction when the determination means determines that the obstacle does not interrupts the operation, and for controlling the operation object to execute another operation different from the operation corresponding to the operation instruction when the determination means determines that the obstacle interrupts the operation.

When the user inputs the operation instruction, the determination means determines whether the obstacle interrupts the operation of the operation object before the operation of the operation object is executed. Thus, when the obstacle interrupts the operation of the operation object, the monitor restricts the obstacle from being damaged by the operation of the operation object. Thus, the safety of the operation of the operation object is improved. Further, since the operation object executes the operation different from the operation corresponding to the operation instruction, the user understands the different operation of the operation object so that the user recognizes existence of the obstacle.

Alternatively, the monitor may further include: a notification means for notifying information. The controller controls the notification means to notify the information about existence of the obstacle when the determination means determines that the obstacle interrupts the operation. In this case, the user recognizes easily existence of the obstacle. Thus, convenience of the monitor is improved.

Alternatively, the monitoring means may shoot an image of a compartment of the vehicle. The determination means compares the image shot by the monitoring means with a reference image so that the determination means determines whether the obstacle interrupts the operation of the operation object, and the reference image provides a reference to detect existence of the obstacle in the compartment. In this case, reliability of determination of the existence of the obstacle is improved.

Alternatively, the monitor may further include: an operation means for transmitting the operation instruction wirelessly; and a first communication means for communicating with the operation means. The user inputs the operation instruction with using the operation means, and the first communication means inputs the operation instruction to the determination means when the first communication means receives the operation instruction from the operation means. The operation means is capable of remote controlling the operation object. When the user remotely controls the operation object with using the operation means, the user cannot see directly the operation object and confirm existence of the obstacle. However, since the monitor determines whether the obstacle interrupts the operation, the safety of the remote operation is improved.

Alternatively, the monitor may further include: a second operation means for communicating with an external device, which is preliminary set and is not mounted on the vehicle. The controller controls the second communication means to transmit the information about existence of the obstacle to the external device when the determination means determines that the obstacle interrupts the operation. In this case, the user easily recognizes existence of the obstacle with using the external device even when the user is disposed apart from the vehicle. Thus, convenience of the monitor is improved.

According to a second aspect of the present disclosure, an in-vehicle monitor for monitoring a status of a vehicle includes: a camera for shooting an image of the vehicle; a memory for storing a reference image, which is preliminary shot by the camera; an image processor for comparing the image of the vehicle with the reference image so that the image processor determines whether an obstacle interrupts an operation of an operation object, which is operated by a user; and a controller for controlling the operation object to execute the operation corresponding to an operation instruction of the user when the image processor determines that the obstacle does not interrupt the operation, and for controlling the operation object not to execute the operation corresponding to the operation instruction when the image processor determines that the obstacle interrupts the operation.

When the user inputs the operation instruction, the image processor determines whether the obstacle interrupts the operation of the operation object before the operation of the operation object is executed. Thus, when the obstacle interrupts the operation of the operation object, the monitor restricts the obstacle from being damaged by the operation of the operation object. Thus, the safety of the operation of the operation object is improved. Further, since the operation object does not execute the operation, the user recognizes existence of the obstacle.

Alternatively, the image processor may determine that the obstacle interrupts the operation when a difference between the image shot by the camera and the reference image is equal to or larger than a predetermined value. Further, the monitor may further include: a speaker and a display for notifying information to the user; a mobile terminal for inputting the operation instruction by the user; and a communication unit for communicating with the mobile terminal. The speaker and the display notify the information about existence of the obstacle when the image processor determines that the obstacle interrupts the operation. The mobile terminal transmits the operation instruction to the communication unit when the user inputs the operation instruction into the mobile terminal. The communication unit transmits the operation instruction to the image processor, and the image processor determines whether the obstacle interrupts the operation when the image processor receives the operation instruction. Furthermore, the operation object may be a sliding door, a rear seat door, a trunk lid, a power window or a seat, and the image of the vehicle may include a first image around the seat, a second image around the sliding door, the rear seat door and the power window, and a third image around the trunk lid.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An in-vehicle monitor for monitoring a status of a vehicle including a status of an operation object, which is operated by a user, the monitor comprising:
a monitoring means for monitoring the status of the vehicle;
a determination means for determining based on the status of the vehicle whether an obstacle interrupts an operation of the operation object when the user inputs an operation instruction for operating the operation object; and
a controller for controlling the operation object to execute the operation corresponding to the operation instruction when the determination means determines that the obstacle does not interrupts the operation, and for controlling the operation object to execute another operation different from the operation corresponding to the operation instruction when the determination means determines that the obstacle interrupts the operation.

2. The monitor according to claim 1, further comprising:
a notification means for notifying information,
wherein the controller controls the notification means to notify the information about existence of the obstacle when the determination means determines that the obstacle interrupts the operation.

3. The monitor according to claim 1,
wherein the monitoring means shoots an image of a compartment of the vehicle,
wherein the determination means compares the image shot by the monitoring means with a reference image so that the determination means determines whether the obstacle interrupts the operation of the operation object, and
wherein the reference image provides a reference to detect existence of the obstacle in the compartment.

4. The monitor according to claim 1, further comprising:
an operation means for transmitting the operation instruction wirelessly; and
a first communication means for communicating with the operation means,
wherein the user inputs the operation instruction with using the operation means, and
wherein the first communication means inputs the operation instruction to the determination means when the first communication means receives the operation instruction from the operation means.

5. The monitor according to claim 1, further comprising:
a second communication means for communicating with an external device, which is preliminary set and is not mounted on the vehicle,
wherein the controller controls the second communication means to transmit the information about existence of the obstacle to the external device when the determination means determines that the obstacle interrupts the operation.

6. An in-vehicle monitor for monitoring a status of a vehicle comprising:
a camera for shooting an image of the vehicle;
a memory for storing a reference image, which is preliminary shot by the camera;
an image processor for comparing the image of the vehicle with the reference image so that the image processor determines whether an obstacle interrupts an operation of an operation object, which is operated by a user; and
a controller for controlling the operation object to execute the operation corresponding to an operation instruction of the user when the image processor determines that the obstacle does not interrupt the operation, and for controlling the operation object not to execute the operation corresponding to the operation instruction when the image processor determines that the obstacle interrupts the operation.

7. The monitor according to claim 6,
wherein the image processor determines that the obstacle interrupts the operation when a difference between the image shot by the camera and the reference image is equal to or larger than a predetermined value.

8. The monitor according to claim 7, further comprising:
a speaker and a display for notifying information to the user;
a mobile terminal for inputting the operation instruction by the user; and
a communication unit for communicating with the mobile terminal,
wherein the speaker and the display notifies the information about existence of the obstacle when the image processor determines that the obstacle interrupts the operation,
wherein the mobile terminal transmits the operation instruction to the communication unit when the user inputs the operation instruction into the mobile terminal,
wherein the communication unit transmits the operation instruction to the image processor, and
wherein the image processor determines whether the obstacle interrupts the operation when the image processor receives the operation instruction.

9. The monitor according to claim 8,
wherein the operation object is a sliding door, a rear seat door, a trunk lid, a power window or a seat, and
wherein the image of the vehicle includes a first image around the seat, a second image around the sliding door, the rear seat door and the power window, and a third image around the trunk lid.
